(19) United States
(12) Patent Application Publication
(10) Pub. No.: US 2002/0074111 A1
(43) Pub. Date: Jun. 20, 2002

(54) Heat exchanger, in particular for swimming pools

(76) Inventors: Bernd Seeger, Pforzheim (DE); Matthias Gehring, Straubenhardt (DE); Christoph Abraham, Muhlacker (DE); Bernd Michelfelder, Karlsruhe (DE)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 09/981,094

(22) Filed: Oct. 16, 2001

(30) Foreign Application Priority Data
Oct. 18, 2000 (DE) 100 51 756.0

(51) Int. Cl. A61H 33/02; F28D 1/00; F28D 7/12

(52) U.S. Cl. 165/163; 165/156; 4/545

(57) ABSTRACT

A heat exchanger for swimming pools, formed of generally cylindrical housing, through which flows a first medium while a second medium flows through a line designed as a spiral within the housing. The spiral shaped line is formed of a corrugated hose and possesses separate connection fittings for the second medium, namely the corrugated hose. The corrugated hose is connected by its end sections which extend in an axial direction to likewise axially extending sections of the separate connection fittings for the second medium.

### BACKGROUND

The invention concerns a heat exchanger, in particular for swimming pools, which heat exchanger comprises essentially, a cylindrical housing, through which a first medium axially flows, wherein the housing possesses fittings on its axial ends for connection with adjacent flow line sections for a first medium, while, by means of two separate fittings, that extend radially outward from the housing, a second medium flows through a spiral coil line placed within the housing, the longitudinal axis of the spiral coil extends parallel to, or coincident with the longitudinal axis of the housing.

Swimming pool heat exchangers of this type have be employed to heat the pool water as a first medium with hot water as a second medium, wherein the ratio of the flow of pool water to the flow of hot water lies in an area of about 5 to 1. Operating on this principle, the pool water flows in an axial direction, and in a direction counter to this, the hot water flows through its line within the housing, which line is spirally coiled to increase the heat transfer surface. In order to obtain a reliable loading of the spiral line, normally, a cylindrical baffle is placed within the coil, which displaces the pool water to flow around the hot water line. Such types of heat exchanger are also known in other fields, for example, even for fuel coolers, as is disclosed in the DE-A-34 40 060.

As a rule, for the swimming pool water applications, the spiral shaped hot water line is comprised of stainless steel, as is the housing. In particularly aggressive usages, such as in cases where mineral or sea water baths are concerned, the components are made of titanium. Quite universally, the type of construction includes spiral coils and interiorly placed baffle elements, which leads to relatively large construction volume with a correspondingly heavy weight. This large construction volume, because of the high cost materials which are used throughout, also has a correspondingly high cost for manufacture.

### SUMMARY

Considering this state of the art, the present invention has the object of providing a heat exchanger, especially for swimming pools, which heat exchanger has a reduced installation space, and also provides a simplified means of installation and a more favorable means of manufacture.

In accordance with the invention, this object is achieved, in that the spiral coiled line for the second medium comprises a corrugated hose, and in that, the corrugated hose possesses end sections that extend in the axial direction, and that also the separate fittings for the second medium, in the interior of the housing, have sections running in the axial direction, and that these end sections of the corrugated hose can be connected to the separate fittings for the second medium.

To begin with, the employment of a spiral shaped, corrugated hose, of same line length and equal inside diameter leads to a substantial increase of surface, (for example, more than double), which in turn allows the hot water line to be designed correspondingly shorter. Since, besides this, the corrugated hose can be sharply bent, the use of the corrugated hose spiral allows the spiral diameter to be substantially reduced and, actually, reduced to such a point, that the use of a baffle plate in the central spiral area can be dispensed with. All in all, in this way, a heat exchanger is obtained, which has a relatively considerably reduced installation space requirement, because of the reduced hot line length, the reduced spiral diameter, and the correspondingly reduced housing diameter. Through the material savings, the cost of manufacture is also correspondingly reduced.

A particular advantage of the heat exchanger in accordance with the invention lies in that, the connection fittings for the second medium, i.e. the hot water, even when they protrude radially outward from the housing, in the housing interior possess sections which are turned axially, onto which the connection of the axial end pieces of the corrugated hose is made. In the state of the art, an essential problem exists in the installation of the heat exchanger, in that the inside, spiral shaped tube, must be welded at the housing ends, so as to align with the radial, outer connection fittings. The present invention avoids these connection problems and proposes, that two end fittings on the housing be provided in addition to the corrugated hose, which fittings enable hot water connections to be made on the outside and, allow axially positioned connections to the respective corrugated hose ends on the inside. In a transition zone of the housing, the two said fittings pass through an axial or a radial housing opening. It is easily seen, that by this construction, the heat exchanger of the present invention can be installed with a considerably simplified economy of labor time and expense.

The connection between the axial aligned end sections of the corrugated hose and the sections of the separate connection fittings, which likewise extend in an axial direction, is done in the interior of the housing. Advantageously, the corrugated hose sections are inserted into the separate connection fittings for the second medium and are secured there by a force fit. In this operation, the rigidity of the spiral allows the end sections of the corrugated hose, by means of a simple plug-in operation to be placed within the separate fittings for the second medium. Because of this rigidity, the connection is reliably held in the originally installed position. Advantageously, the insertion of one component within another, namely the plugging-in of the ends of the corrugated hose sections into the separate connection fittings for the second medium, can be carried out simultaneously with the installation of the housing. This makes a stable and tight connection to last through the operational life of the heat exchanger, at least, when the exchanger is used for media which do not put the corrugated hose into extreme motion relative to the housing and the separate fittings attached thereto.

An alternative design for the securement of the corrugated hose sections, is that the end sections of the corrugated hose extending in the axial direction are affixed by means of separate retaining elements, which are advantageously inserted into the housing and retained there, again by a form-fit.

With this design, it becomes possible to install the corrugated hose in the housing, even before the separate fittings for the second medium and do so in such a manner, that an expenditure in time and money is clearly minimized for the eventual installation of these separate connections.

In a preferred embodiment of this variant, the corrugated hose is inserted in a cylindrical casing of the housing, wherein it is laid in spiral shape and the end sections of the corrugated hose extend axially and respectively coact with a holding element. This holding element possesses a cylindrical boring through which the axial end section of the corrugated hose is inserted and made fast. The dimensioning of the holding element is such that it makes a tight fit within the inside dimensions of the housing into which it is inserted. This holding element firmly positions the corrugated hose in the housing to face the separate connection fitting which is later to carry the second medium.

On each axial end of the unit, now formed by the housing casing, the corrugated hose and the holding element, a housing end piece is attached. Each of these end pieces carries a separate connection for the second medium. The connection of the housing end pieces to the casing of the housing is done in such a manner, that the separate connection fitting for the second medium can be joined to the holding element, that is, affixed in a media-tight manner to the corrugated hose carried by the holding element. In this way, the corrugated hose ends and separate connection for the second medium are placed flush with one another, whereby, at the same time, the housing end pieces are secured to the axial ends of the housing casing.

More advantageously, the opposed end fastening of separate connection fittings for the second medium, the holding element and the housing end piece, onto the casing of the housing can be done by welding, especially if the said components are made of plastic. These two welded connections can, indeed, be simultaneously done. In doing this, however, care must be taken that after the completed welding, the sealing of the internal welded connection can no longer be inspected nor can it be renewed.

On this account, the recommendation is, to choose the dimensioning in such away that upon the attachment of the housing end-pieces onto the housing casing, first, the separate connections for the second medium and the respective holding elements are brought into position at both ends of the housing. The dimensioning should also be such that the end position of the housing end piece and the housing casing can only be achieved, when the first welding procedure is at least nearly completed and at which time each separate connection and its corresponding holding element are bound together in a media tight manner.

The aspect of the present invention, as described above, is also effective in the case of other types of housing construction, on which account the respective description is to considered only as an example, but not to be seen, however, as limiting protection. Thus, for instance, a holding element can also be more firm and in some cases, a one-piece component of the housing, so that the installation of the corrugated hose is done through the open housing end, and in this way the second corrugated hose end is secured by means of a separate holding element in the housing. In this case, it would be possible, to connect the separate connection for the second medium onto the said integrated holding element either as one piece or as a separate component and thus also on the first end of the corrugated hose, so that essentially the second separate connection for the second medium, is connected after the installation of the spiral hose and the securement of the second corrugated hose end by means of the holding element. Then, the housing in the zone of this second separate connection must be closed. Even with this variant, is would be possible—especially, if the housing is cylindrical—to extend its length to suit optional heat exchanger capacities at different locations and then to be able to connect a correspondingly dimensioned end piece for the closure of the housing.

In order to provide a lasting securement for the corrugated hose ends, not only for the installation procedure, but also for a later reliable operation, it is recommended, to so arrange holding rods in the area of the holding element, that they insert themselves into corrugation recess in the area of the hose circumference and thus affix the hose in the axial direction. For this purpose, the holding rods, for example, can be inserted through provided borings provided in the holding element and, more preferably for each corrugated hose end, at least two diametrically opposed holding rods be so installed.

As already mentioned, the first medium, as a rule consists of swimming pool water, while the second medium is the heating means, namely, hot water. Nevertheless, the present heat exchanger is suitable for the cooling of a first fluid, wherein the second medium must then show a reduced temperature as compared to the first fluid temperature. Along with this it is also possible, to employ the heat exchanger for other media combinations, for example, for the heating of supply water for thermal baths or for fuel cells and the like. The heat exchanger may also be applied to heat recovery and, in general, for a multiplicity of industrial uses, in the area of automobile manufacture, in short, anyplace where heat exchangers with cooling or heating spiral shapes are installed.

A current application area for the present invention is based on the construction of the separate connections for the corrugated hose. The design is such that the tubular elbows, originally extending radially outward from the outside of the housing, penetrate housing wall at such an angle, that in the interior of the housing, the axial direction of a part becomes parallel to, or identical with the axis of the hose spiral. In this arrangement, the corresponding, axial, end sections of the corrugated hose connect with the corresponding, axial terminations of the elbow fittings. This type of construction is especially employed in the case of the said swimming pool water heating. On this account, and for the sake of simplicity, as well as for a better explanation, without intending any limitations, mention of the special elbow construction is intended, when, per se, a concern about separate connections for the second medium is spoken of in entirely general terms. These connections, naturally, can also, under circumstances, penetrate the housing wall in the axial direction through the housing ends.

In a practical way, the housing has a multipiece design for the installation of the corrugated hose spiral, and, in a most advantageous manner, is formed of a cylindrical housing casing and two separate end pieces which carry the elbows and connections.

These end parts are normally secured to the housing casing by welding or by adhesive means. The installation, in this case, would be carried out in such a way, that the corrugated hose is shaped into the desired spiral, the elbows are respectively affixed to the end pieces of said hose, insofar as said end pieces have not already been molded onto the elbows, and subsequently, respectively an elbow is placed on each end piece of the cylindrical housing casing, while, at the same time, the housing casing is brought into alignment on the two housing end pieces, and then all three can be affixed to one another.

Besides the possibility of molding the separate connections, i.e. the elbows, directly onto the housing casing, and particularly to mold them onto the housing end pieces, these elbows can, naturally, be made separate from the housing, whereby, then the elbows can be inserted through openings provided in the housing and affixed thereto in a medium tight manner.

Likewise, the connection between the corrugated hose and the elbow connections must be made medium fight, to which end, advantageously, between the corrugated hose end section and the axial section of the separate elbow connections, a sealing element is placed. A sealing element for this service can be so designed, that it is forced onto the corrugated hose end section so that it overlaps the circumference thereof along a certain length, at least between two corrugation recesses, wherein it engages the recesses in a form-fit manner. Beyond this, the sealing element, on its outer end proximal to a facing elbow end is provided with at least one circumferentially running sealing lip, which sealingly engages the inside of the elbow wall. A sealing element designed in this manner possesses the essential advantage, that, because of its form-fit connection, has a durable grip on the corrugated hose. Further, beyond that advantage, this type of fit aids the previously mentioned plug-in installation of the corrugated hose and the elbow. In addition to this, because of frictional rubbing between the corrugated hose and the elbow, this sealing element is in the position to accept greater pressures, without the necessity that an additional holding element must secure the corrugated hose onto the elbow.

Another, and even simpler construction of the sealing element is provided by placing two O-rings on a corrugated hose end section, which respectively engage themselves in corrugation recesses and so grip the entire inside circumference of the elbow end. For this operation, the corrugated hose end section must essentially extend over the axially extending length (without being stretched) of the elbow and in regard to its diameter, should advantageously be grooved, in order that by this means, any unevenness in manufacturing might be compensated for.

To increase the axial retention of the corrugated hose in the elbow—especially in cases of great pressure differences between the first and second medium—at least one of the corrugated end sections should coact with a holding means.

This holding means can be formed by a catch connection similar to a barbed surface. Another holding means can be designed, in that the holding material is placed on the corrugated hose in combination with the sealing element, and both are inserted together into the elbow, whereby the holding means should be so dimensioned as to its diameter compared to the inside diameter of the elbow, that it lies compressed against the inside of the elbow, whereby the holding material seats itself by a shape fit in the corrugated hose.

More advantageous, the axial section of the separate connections, that is, the elbows which are sealingly contacted by the corrugated hose, are designed as smooth surfaced, cylinders in order to favor the insertion type assembly, as well as the setting of the sealing element. Otherwise the corrugated hose end section can simply be formed by a corrugated hose part made from an elongation in the axial direction, or moreover, somewhat reduced in its flexibility by stretching, so that, in the area of the junction with the elbow as far as possible, only forces in the axial direction are permitted and no transverse forces become effective, as would be the case with a highly flexible corrugated hose end, which was bent inward radially from the circumference of the spiral in the direction of the spiral axis and at that point was once again bowed in the direction of the spiral axis.

The end section of the corrugated hose, which extends in the axial direction, can also be made from a smooth walled tube connected to the corrugated hose.

This can be done, for instance, by welding, wherein the end section could then be inserted into the plug-in connection of the separate connection, i.e., the elbow. For this purpose the tube, on its outer side can have groove shaped recesses, into which O-rings can be inset for the sealing of the said plug-in connection. This embodiment should, in accordance with the invention, be looked upon expressly as a variant which falls under the present principal claim of the corrugated hose end section.

In order to favor complete circulation about the spiral of corrugated hose, it is particularly advantageous, if, between the corrugated hose spiral and the housing inner shell, combination spacers and holding means are provided, creating a space through which the first medium, namely the pool water, can flow. The spacers should be so designed, that they favor the previously mentioned plug-in type assembly, and can be, for instance, spacer webs extending in the plug-in direction. The webs would be molded into the interior of the casing of the housing. Likewise, on the corrugated hose spiral, O-rings can be added, which protrude above the corrugation risers and in this way make available the necessary spacing of the spiral to the inner wall of the housing as well as the spacing of the turns, one to another.

The mentioned spacing devices have still more advantages, in that by means of these, the corrugated hose is supported, in order to prevent flow induced noise emission. In connection with this, it should be mentioned, that not only for the improvement of the circulation about the spiral, but also for the prevention of flow derived noises, it is worthy of recommendation to install one or more baffle vanes in the form of impact plates in the housing and in the corrugated hose spiral.

A particular advantage of the inventive, simplified field assembly of the heat exchanger, is provided in that principally, the reliable surfaces responsible for heat exchange, which include the corrugated hose, must be fabricated from stainless steel, while the separate connections, that is the elbows, as well as the housing, can be of corrosion resistant plastic, whereby the costs of the inventive heat exchanger can, once again, be drastically reduced.

Contrary to this, in accordance with the state of the technology, the spiral shaped line must be welded onto the housing in the neighborhood of the radial opening, and brought into connection with the radial connections, so that, even for the housing, weldable, corrosion resistant material, i.e., stainless steel was required. On the other hand, in the case of the heat exchanger in accordance with the invention, the connection of the corrugated hose and the elbow, on the contrary, is effected by plug-in means without welding. Even if, for whatever grounds, the elbow is likewise made of stainless steel, then nevertheless, the entire housing can be comprised of plastic and again a substantial cost reduction is made possible. Acceptable plastic materials are considered to be: polyamide, polypropylene, polyethylene and polyvinylidene-chloride.

### BRIEF DESCRIPTION OF THE DRAWINGS

Additional features and advantages of the invention will become evident from the following description of two preferred embodiments shown in the drawings. There is shown in:

FIG. 1 is a sectional, profile view of a heat exchanger in accordance with the invention;

FIG. 2 is a cross-sectional view taken along the line A-B of FIG. 1 of the heat exchanger of FIG. 1;

FIG. 3 is a sectional, profile view of an alternative embodiment of a heat exchanger in accordance with the invention;

FIG. 4 is a sectional, profile view of a further alternative embodiment of a heat exchanger in accordance with the invention; and

FIG. 5 is a cross-sectional view taken along the line A-B of FIG. 4 of the heat exchanger of FIG. 4.

### DETAILED DESCRIPTION OF THE PREFERRED EMBODIMENTS

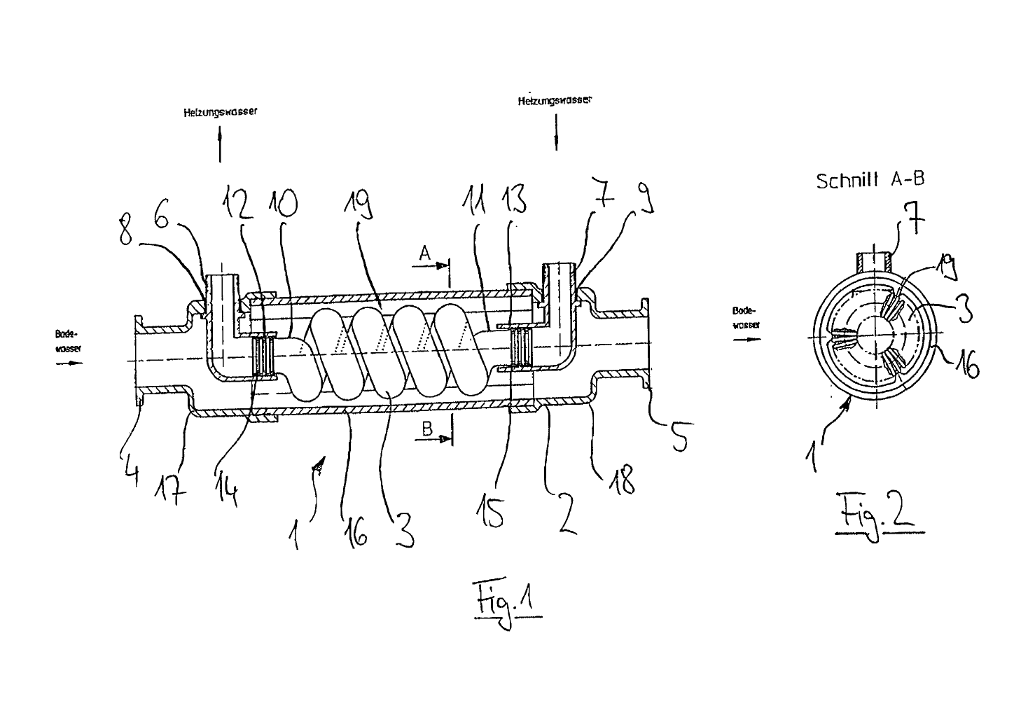

The heat exchanger 1 presented in FIG. 1 is comprised of a somewhat cylindrical housing 2 and a corrugated hose spiral 3 placed in the housing 2. While a first medium, in the present instant, this being swimming pool water, flows into and out of the housing through, respectively, connections 4, 5, a second medium, in this case, hot water, flows through the corrugated hose spiral 3. The corrugated hose 3 is connected to two L-shaped elbows 6, 7 which, are inserted into the heat exchanger housing through the openings 8 and 9. The elbows 6, 7 protrude radially outwardly, where they can be connected to neighboring line sections.

The connection between the axially oriented corrugated hose end sections 10, 11 and the elbow end pieces 12, 13 which likewise run in the axial direction is accomplished by a plug-in method, whereby, respectively between corrugated hose and the elbow, a sealing element 14, 15 is placed. This sealing element 14, 15 engages itself in a form-fit manner in the end corrugations and extends over at least two corrugations.

Because of the rigidity of the corrugated hose made into the spiral form, this seats itself with its axial aligned ends securely between the elbows and thus in the oppositely connected position. Moreover, the end pieces 12, 13 of the elbows 6, 7 are made sufficiently long in the axial direction, so that this piece can be advantageously employed to make available a relatively large overlapped connection area of corrugated hose and elbow end at both ends, which assures a reliable mutual connection even when the end pieces of the corrugated hose and the elbows move in relation to one another.

The heat exchanger housing 2 is, in its totality, constructed of three molded pieces, including a cylindrical casing 16 and two end pieces 17, 18, which carry the elbows 6, 7 and also carry the pool water connections 4, 5. The assembly of the housing parts is done in the same manner as the assembly of the elbows and the corrugated hose, by means of axial insertion of one part into the other, wherein the housing parts can then be adhesively joined together or welded. Likewise the connection between the elbows onto the end pieces is carried out by either adhesion or welding.

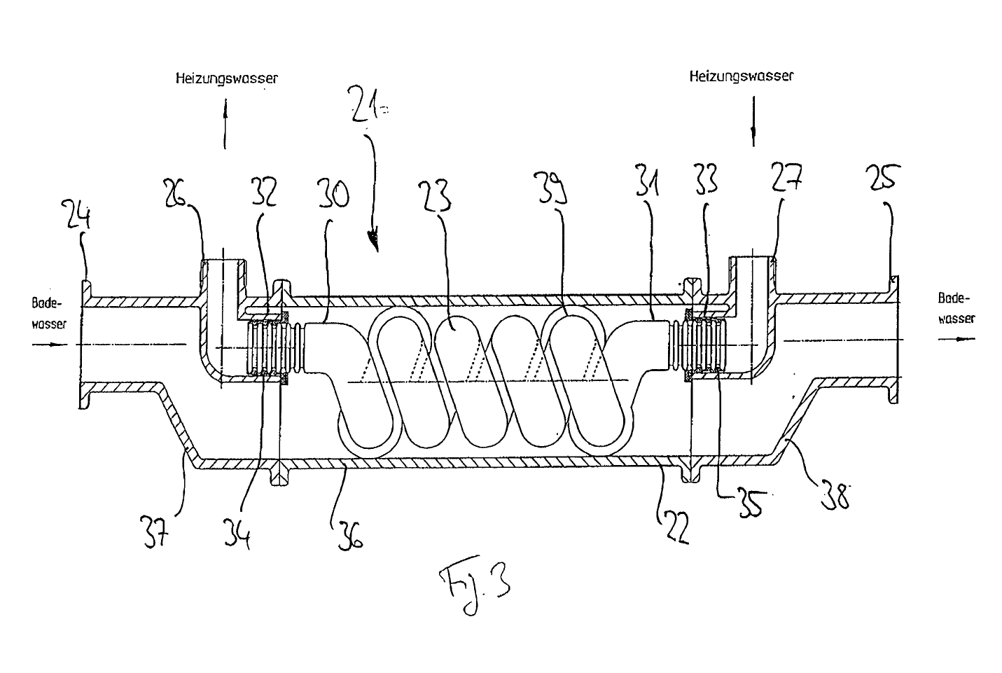

Spacer webs 19, extending in the axial direction, are to be seen in FIG. 2, which shows section A-B (taken along section line AB of FIG. 1). These spacers 19 are molded on the inside of the cylindrical housing casing 16 and serve as spacers for the corrugated hose and perform the function of enabling a surrounding flow contact both on the outside of the corrugated hose as well as in the open space formed between the housing and the corrugated hose.

These spacers also have the additional duty of stabilizing the corrugated hose, in order to avoid flow induced vibrations of the corrugated hose spiral.

Although, in the case of the heat exchanger presented in FIG. 1, the end pieces of the corrugated hose as well as the end pieces of the elbows are aligned along the common spiral and housing axis, the same end pieces in the heat exchanger depicted in FIG. 3 are offset from the said spiral/housing axis in such a manner, that these end pieces are somewhat elevated in relation to the installation position so that the uppermost point of the outside diameter of the of the corrugated hose end piece aligns with the corresponding uppermost point of the spiral outside diameter.

Other than this, to a great extent, the designs of the two heat exchangers correspond to the greatest extent. Again in the case of FIG. 3, the heat exchanger housing 22 is three parts, and comprises a cylindrical housing casing 36, the two end pieces 37, 38 and a corrugated hose spiral 23 with axially extending end sections 30, 31. Between these end sections 30, 31 and the axially directed end sections 32, 33, of the elbows 26, 27, are interposed two sealing collars 34, 35, which, on their respective corrugated hose proximal end possess a circumferential collar, which serves as a detent upon insertion into the elbow, since the detent protrudes outward relative to the elbow and upon the insertion, abuts against the end surface of the of the elbow end section.

In the case of the construction type of FIG. 3, moreover, the axial connections 24, 25 of the heat exchanger housing 22 are asymmetric, thus offset to the housing central longitudinal axis in such a manner, that they align themselves, when assembled, with the top of the central portion of the housing 22. This alignment offset is made in order that the air which may be present in the heat exchanger housing is transported away, whereby the risk of corrosion can be reduced.

Finally, instead of the spacer webs 19 of FIG. 1, O-rings 39 are placed on the corrugated hose to perform as spacers and holders between the corrugated hose and the interior of the wall of the cylindrical casing of the housing. These spacers keep the corrugated hose spiral at a defined distance from the housing.

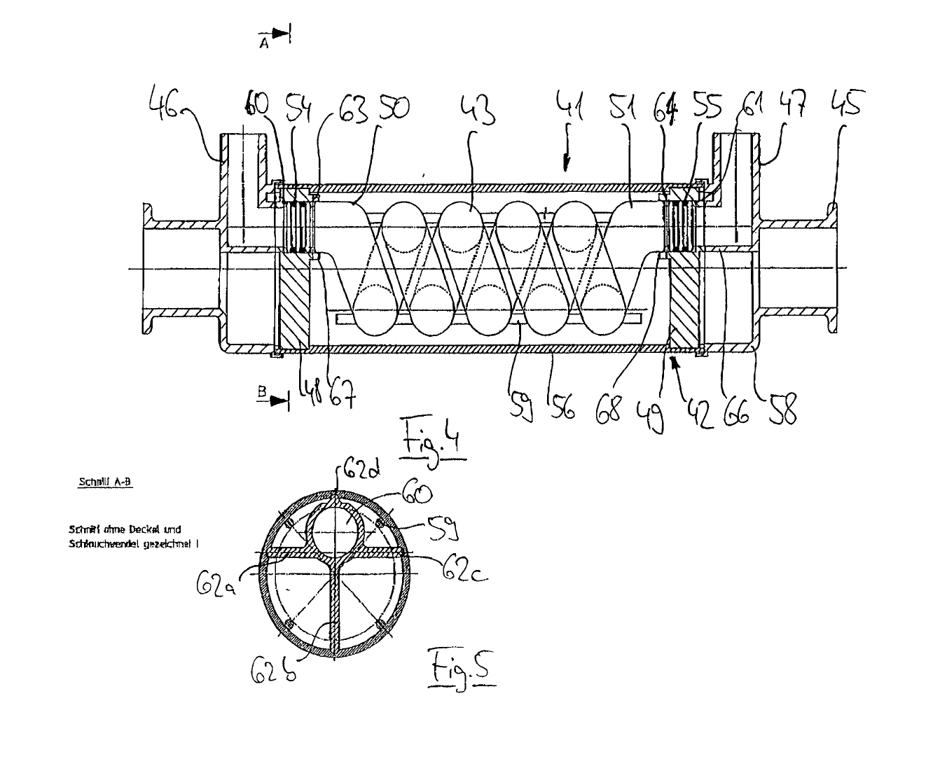

FIG. 4 shows the second main embodiment of the present invention. In FIG. 4, a heat exchanger 41 is presented, which comprises a housing 42 and a spiral shaped, corrugated hose line 43 inserted therein to carry the second medium. The housing 42, which is similar to the housing 2 of FIG. 1, is comprised of a cylindrical, housing casing 56 and two housing end pieces 57, 58 placed upon the ends of the housing casing. These housing end pieces 57, 58 possess respectively, a fitting 44, 45 with an extended nipple for connection to the first medium as well as having respectively separate, elbow-like connections 46, 45 to carry the second medium. To this extent, the design of FIG. 4 corresponds with that of FIG. 1.

Similar to the construction as shown in FIG. 3, the connections for the first medium, as well as the separate connections for the connections for the second medium are an integral and single piece component of the housing end pieces 57 and 58. In this respect, the elbow-like connections 46, 47 for the first medium do not extend themselves along the axis of the spiral and the housing, but, rather, their axial sections, which serve for the connection of the corrugated hose, are asymmetric, that is, they are offset above the common axis of the housing and the spiral. This offset is such that these elbow-like connections 46, 47 align themselves with the elevated, axially oriented, corrugated hose ends at the extreme ends of the spiral section of the screw-thread-like extension. This arrangement allows, that the top of the axially extending section of the elbow for the second medium aligns itself with the top of the outer circumference of the hose spiral.

The essential difference to the construction types of the FIGS. 1 and 3 are found in the fact, that the corrugated hose 43, with its axially oriented ends 50, 51 is inserted into holding elements 48, 49. These holding elements are depicted in FIG. 5 in sectional view and respectively possess a boring 60, 61, into which the corrugated hose ends 50, 51 are inserted.

Beyond this, the holding elements 48, 49 possess, in the present example, four spreader legs 62a, 62b, 62c, 62d, by means of which the spiral is held within the cylindrical mid-section housing 56. For this purpose, the spreader legs are made to fit, in their outside dimensioning the inner measurement of the cylindrical, casing housing 56 and are inserted in axially aligned grooves on the inner wall of the housing casing 56, whereby the grooves of the legs 62a to 62d are stressed and serve as a securement against the rotation of the holding elements and serve further for the improvement of the form fitting between the holding element and the housing.

The insertion of the corrugated hose end 50, 51 into the boring 60, 61 of the holding element 48, 49 is done along with the interposing of a sealing element 54, 55 in the form of, for example, two O-rings. Moreover, holding pins 63, 64 are provided which engage in a recess of the corrugation of the corrugated hose 43 and also transverse the holding element 48,49, in order to assure, once again, the axial positioning of the corrugated hose.

The mentioned separate connections 46, 47 for the second medium are aligned with, and connected in a medium-tight manner to the borings 60, 61 by means of their sections 65, 66 which extend in the axial direction, which connection can be made by welding, whereby the housing end pieces 57, 58, which carry the separate connections 46, 47, are also simultaneously bound to the housing casing 56.

The assembly of the heat exchanger of FIG. 4 is done in the following steps: on the corrugated hose, in the area of the two ends, respectively two O-rings 54 are installed in the last two corrugation depressions. On one of the two corrugated hose ends 50, 51 a holding element 48 is subsequently pushed on and affixed with the holding pin 63. Now the hose spiral, with the holding element, is pushed into cylindrical mid-section 56 of the housing, until the axial, outer end side of the holding element 48 tightly closes with the outer end face of the casing of the housing, whereby this insertion of the holding elements into the housing is limited by a detent on the inside of the housing.

Subsequently, the second holding element 49 is pushed onto the second corrugated hose end 51, and fixed in place by the holding pin 64 and inserted into the housing casing 56 until it abuts a corresponding detent 68. The tightness of the seal of the connections between the corrugated hose and the holding element, as well as of the corrugated hose itself can be immediately checked at this premounted assembly group, even before the connections for the two media and the housing end pieces are closed. After a possible examination of the tightness of the sealing, the two housing end pieces 57, 58, which carry the connections 46, 47 and 44, 45, are set into the ends of the cylindrical housing casing and by means of vibration welding, the separate connections for the second medium, in the area of their sections running in the axial direction are affixed to the holding elements 48, 49 and almost simultaneous thereafter, the end pieces 57, 58 are welded onto the housing casing 56.

All together, the present invention offers the advantage of making available a heat exchanger for various uses, and especially for swimming pool application, which, with the same heating load, has about a fifty percent reduced weight, a considerably reduced size for installation, and in accordance with these features, also a reduced cost of manufacture. The manufacturing costs can be further reduced in that the housing and the elbow, that is, the separate connections, can be made of economically obtained plastic material. Beyond this, the inventive heat exchanger is characterized by a considerably simplified expenditure for field assembly, since the corrugated hose, in one embodiment, can be connected to the separate fittings by a simple mutual insertion operation. Because of the axial rigidity of the corrugated hose, the plug-in arrangement is sufficient for long lasting connections. Thus, the connection area between the corrugated hose with the elbows or with the separate connections does not need to be supported by an additional securement means. In fact, no connection area needs to be so supported.

For improved assembly possibilities, the housing is constructed as a multipart unit, wherein various parting planes come into question. Especially advantageous is a subdivision into one cylindrical housing casing and two end pieces which carry the elbows, which are constructed identically and thus can be manufactured with the aid of the same tools.

The plastic material for the heat exchanger housing, because of the substantially reduced outside diameter, has the positive side effect, that it is scarcely noticeable in relation to the remaining line sections for the swimming pool water. Principally, the two radial connections for the heating medium become an indicator for the position of the heat exchanger.

Because of the stated considerably reduced heat exchanger diameter, it is not possible in any case to provide connections, at the axial housing end surfaces, for both the swimming pool water as well as for the hot water. On this account, the radial orientation of the hot water connections in the present embodiment case, cannot be dispensed with. This radial orientation conforms, however, to the required conditions of construction, which are of such a nature, that the hot water connections, in relation to the pool water lines and the heat exchanger must be directed toward a neighboring heating apparatus. As has been previously mentioned, the present invention extends to other types of construction, in the case of some of which, connections for both media can leave the housing in the axial direction.

The small space requirements, which became possible in the case of the inventive heat exchanger, can only be attained, i.e. realized, in the carrying out of a semi-blind insertion of one housing component into another and in the connection of the line elements. Only by means of the inventive assembly procedure of corrugated hose sections and elbow end sections, can the heat exchanger, in its totality, be built so small and as simple as is possible in relation to the spiral dimensioning.

What is claimed is:

1. A heat exchanger, especially for swimming pools, comprised of a generally cylindrical housing (2, 22, 42), which provides for a generally axial through-flow of a first medium, wherein the housing, at its axially located ends (17, 18, 37, 38, 57, 58) includes connection fittings (4, 5, 24, 25, 44, 45) for connection to adjacent line sections for the first medium, while a second medium flows through two separate connection fittings (6, 7, 26, 27, 46, 47) and through a line installed within the housing which is formed into a spiral (3, 23, 43), an axis of which is parallel to and/or coincident with, an axis of the housing, wherein, the spiral shaped line for the second medium is comprised of a corrugated hose, the corrugated hose includes end sections (10, 11, 30, 31, 50, 51) which extend in the axial direction, and the separate connection fittings (6, 7, 26, 27, 46, 47) for the second medium have axially extending end sections (12, 13, 32, 33, 65, 66) in an interior of the housing, and the axially extending end sections of the corrugated hose within the housing are connected to the separate connection fittings for the second medium.

2. A heat exchanger in accordance with claim 1, wherein the separate connection fittings (6, 7, 26, 27, 46, 47) for the corrugated hose (3, 23, 43) are designed as tubular elbows, that include a radially extending section that extends outside of the housing (2, 22, 42) through a penetration of a wall of the housing into the interior thereof, and a bent section that extends in a direction parallel to, or coincident with, the axis of the spiral.

3. A heat exchanger in accordance with claim 1, wherein the axially extending end sections (10, 11, 30, 31) of the corrugated hose (3, 23) are inserted into the axially extending end sections (12, 13, 32, 33) of the separate connection fittings (6, 7, 26, 27) for the second medium and are secured in that position by these insertion connections.

4. A heat exchanger in accordance with claim 1, wherein the axially extending end section of the corrugated hose is formed by a smooth walled tube attached thereto, which penetrates into a plug-in connection with the separate connection fitting for the second medium.

5. A heat exchanger in accordance with claim 1, wherein the corrugated hose (43) end sections (50, 51) which extend in an axial direction are firmly secured by holding elements (48, 49).

6. A heat exchanger in accordance with claim 5, wherein the holding elements (48, 49) are inserted in the housing (42, 56).

7. A heat exchanger in accordance with at least claim 6, wherein the holding elements (48, 49) in the housing (42, 56) are retained therein by a form fit.

8. A heat exchanger in accordance with claim 5, wherein the holding elements (48, 49), are made to fit an inside dimensioning of the housing for securement in the housing (42, 56).

9. A heat exchanger in accordance with claim 5, wherein the holding elements (48, 49) include cylindrical borings (60, 61), onto which the end sections (50, 51) of the corrugated hose (43) are attached.

10. A heat exchanger in accordance with claim 9, wherein the end sections (50, 51) of the corrugated hose (43) are inserted in the borings (60, 61) of the holding elements (48, 49).

11. A heat exchanger in accordance with claim 5, wherein the separate connection fittings (46, 47, 65, 66) for the second medium are connected medium tight to the holding elements (48, 49).

12. A heat exchanger in accordance with claim 11, wherein the holding elements (48, 49) are made of plastic, and the connection of separate, plastic, connection fittings (46, 47) made of plastic to holding elements (48, 49) is made by welding.

13. A heat exchanger in accordance with claim 1, wherein the housing (2, 22, 42) is a multipart construction to aid in assembly of the corrugated hose spiral (3, 23, 43).

14. A heat exchanger in accordance with claim 13, wherein the housing (2, 22, 42) is comprised of a cylindrical casing (16, 36, 56) and of two end pieces (17, 18, 37, 38, 57, 58),the end pieces carry the connection fittings (4, 5, 24, 25, 44, 45) for the first medium and the separate connection fittings (6, 7, 26, 27, 46, 47) for the second medium.

15. A heat exchanger in accordance with claim 1, wherein the separate connection fittings (26, 27, 46, 47) for the second medium are molded onto the housing (22, 42).

16. A heat exchanger in accordance with claim 1, wherein the separate connection fittings (6, 7) for the second medium are made separate from the housing (2), wherein the said connection fittings are inserted through the housing opening (8, 9).

17. A heat exchanger in accordance with claim 1, wherein the axial corrugated hose end sections (10, 11, 30, 31, 50, 51) for the second medium are provided with a sealing element (14, 15, 34, 35, 54, 55) for sealing against the separate connection fittings (6, 7,26, 27, 46, 47).

18. A heat exchanger in accordance with claim 17, wherein
the sealing element (14, 15, 34, 35) is pushed onto one of the respective corrugated hose end pieces (10, 11, 30, 31), and the sealing element overlaps a circumference of the corrugated hose between at least two corrugation recesses and engages itself in the at least two corrugation recesses.

19. A heat exchanger in accordance with claim 18, wherein on an outer side of the sealing element (14, 15, 34, 35) which contacts the axial section (12, 13, 32, 33) of the separate connection fittings (6, 7, 26, 27) for the second medium, at least one circumferential sealing lip is provided, which lies on an inner side of the axial section.

20. A heat exchanger, in accordance with claim 17, wherein the sealing element (54, 55) is comprised of at least one O-ring, which is circumferentially placed upon the corresponding corrugated hose end section (50, 51), engages thereof in formfit manner in at least one corrugation recess and with an outer side, which sealingly contacts the axial section (12, 13, 32, 33) of the separate connection fittings (46, 47) for the second medium, lies against the inner wall of the axial section.

21. A heat exchanger in accordance with claim 1, wherein the sealingly contacted, axial section of the separate connection fittings (6, 7, 26, 27) for the second medium are constructed as smooth cylinders.

22. A heat exchanger in accordance with claim 1, wherein the housing (2, 22, 42) and/or the separate connection fittings (6, 7, 26, 27, 46, 37) for the second medium are formed of plastic material.

23. A heat exchanger in accordance with claim 1, wherein between the corrugated hose (3, 23, 43) and the housing (2, 22, 42), a spacing retainer (19, 39, 59) is provided.

24. A heat exchanger in accordance with claim 1, wherein,
the first medium is swimming pool water and
the second medium is heating water.
